(19) United States
(12) Patent Application Publication
(10) Pub. No.: US 2018/0069636 A1
(43) Pub. Date: Mar. 8, 2018

(54) Hybrid Direct-Detection Differential Phase Shift Keying-Multipulse Pulse Position Modulation Techniques for Optical Communication Systems

(71) Applicants: Egypt Japan University of Science and Technology, Alexandria (EG); Zewail City of Science and Technology, Garden City (EG)

(72) Inventors: Ahmed E. Morra, Shibin El-Kom Menoufia (EG); Hossam M. H. Shalaby, Alexandria (EG); Salah Sabry Obayya, 6th of October City (EG); Salem Farag Salem Hegazy, Faisal (EG)

(21) Appl. No.: 15/256,937

(22) Filed: Sep. 6, 2016

(51) Int. Cl. H04B 10/516; H04B 10/61

(52) U.S. Cl. CPC H04B 10/5161; H04B 10/612; H04B 10/616

(57) ABSTRACT

A hybrid differential phase shift keying-multipulse pulse position modulation (DPSK-MPPM) technique to enhance the receiver sensitivity of optical communication systems is presented. Both binary and quadrature formats are adopted in the proposed systems. Direct-detection DPSK schemes that are based on asymmetric Mach-Zehnder interferometers with a novel ultrafast discrete delay unit are presented to simplify the receiver implementation. Our results reveal that the proposed hybrid schemes are more energy-efficient and have higher receiver sensitivity compared with the traditional ones while improving the bandwidth-utilization efficiency. Furthermore, at an average launch power of −8 dBm and BER=10⁻³, the hybrid DQPSK-MPPM system with a total frame length of eight time slots including two signal time slots outreaches a traditional DQPSK system by 950 km. The proposed DPSK-MPPM modulation system accommodates adjustable (or variable) bit rates, by virtue of the programmable delay integrated to the receiver system.

### FIELD OF THE INVENTION

The proposed direct-detection hybrid modulation schemes are more energy-efficient than traditional ones and have improved bit error rates (BERs) and receiver sensitivities and still improve the bandwidth-utilization efficiencies.

### BACKGROUND OF THE INVENTION

The sensitivity of the receiver is one of the most important issues for many optical communication systems. Higher receiver sensitivity implies less number of transmitted signal photons per bit at the same BER. Among the preeminent modulation schemes of optical communication systems featuring high receiver sensitivities are differential binary phase shift keying (DBPSK) and differential quadrature phase shift keying (DQPSK). On the other hand, DQPSK is one of the most popular receivers for multilevel phase-modulated optical communication systems and is more bandwidth efficient than DBPSK. Optical differential phase shift keying (DPSK) signals can be directly detected using asymmetric Mach-Zehnder an interferometer. This simplifies the receiver implementation and avoids the need for optical local oscillators and microwave carrier recovery circuits.

Recently, several ideas for optical hybrid-modulation systems have been suggested to enhance the sensitivity of the receiver, including a combination of m-ary pulse position modulation (PPM) or m-ary frequency-shift keying (FSK) with additional polarization and/or phase modulation. The first experimental realization of hybrid polarization-multiplexed-2PPM-quadrature phase-shift keying (PM-2PPM-QPSK) modulation for long-haul transmission at a data rate of 42.8 Gbit/s was then carried out. As a good step to improve the performance of both traditional binary phase shift keying (BPS K) and multipulse pulse position modulation (MPPM) modulation techniques in optical fiber communications, a hybrid BPSK-modified MPPM, which surpasses the traditional BPSK and MPPM modulation techniques has been proposed. A hybrid orthogonal frequency-division multiplexing-pulse-position modulation (OFDM-PPM) technique was then proposed for free-space optical communications (FSO). Furthermore, a hybrid polarization-division-multiplexed quadrature phase-shift keying-MPPM (PDM-QPSK-MPPM) for FSO has also been proposed. An MPPM-L-ary quadrature-amplitude modulation (LQAM) technique was also been investigated.

### SUMMARY OF THE INVENTION

In an attempt to further increase the receiver sensitivity of optical communication systems, this invention teaches a hybrid differential phase shift keying-multipulse pulse position modulation (DPSK-MPPM) techniques. The key idea is to use the sensitivity- and spectrally-efficient DPSK scheme along with an energy-efficient modulation scheme, such as MPPM, to integrate the advantages of both schemes. This is the first time that a hybrid modulation scheme for optical communication systems is based on direct-detection DPSK (DD-DPSK). This significantly simplifies the receiver implementation as it eliminates the need for optical local oscillators or microwave carrier recovery circuits. The performance of the proposed modulation techniques is compared herein to that of traditional DBPSK, DQPSK, and MPPM modulation techniques. Different design parameters, such as BER and bandwidth-utilization efficiency are addressed in the comparisons, under the same conditions of data rate, bandwidth, and average received optical signal-to-noise ratio.

A hybrid differential phase shift keying-multipulse pulse position modulation (DPSK-MPPM) technique is taught herein to enhance the receiver sensitivity of optical communication systems. Both binary and quadrature formats are adopted in the proposed systems. Direct-detection DPSK schemes based on an asymmetric Mach-Zehnder interferometer with a novel ultrafast discrete delay unit are presented to simplify the receiver implementation. Under the constraints of the same transmitted data rate, bandwidth, and average received optical signal-to-noise ratio, the BER performances of the present invention are evaluated numerically and compared with that of traditional differential binary phase shift keying (DBPSK), differential quadrature phase shift keying (DQPSK), and MPPM schemes and with that of recent hybrid schemes. Furthermore, a comparison between the proposed systems and prior art systems is held in terms of the bandwidth-utilization efficiency. The results reveal, taking into account the effect of the optical amplifier noise, that the proposed hybrid schemes are more energy-efficient and have higher receiver sensitivity compared with the traditional ones while improving the bandwidth-utilization efficiency. The DPSK-MPPM modulation system of the present invention accommodates adjustable (or variable) bit rates by virtue of the programmable delay integrated to the receiver system.

While the hybrid DPSK-MPPM technique of the present invention outperforms both traditional DPSK and MPPM techniques under amplified spontaneous emission (ASE) noise (linear limit), it is less robust when fiber nonlinearity is considered. However, under the impact of low nonlinearity, the performance of a hybrid technique still surpasses the traditional ones. In particular, at an average launch power of −8 dBm and a forward-error correction (FEC) requirement of BER=10⁻³, the hybrid DQPSK-MPPM system with a total frame length of eight time slots including two signal time slots outreaches a traditional DQPSK system by 950 km.

### BRIEF DESCRIPTION OF THE DRAWINGS

FIG. 1 is a schematic diagram for K stages of the proposed ultrafast discrete delay unit.

FIG. 2 shows a timing diagram for propagation through 1-, 2-, 3-, and 4-stages polarization-maintaining single-mode (PMSM) fibers when R=2. The dashed lines denote the fast-axis propagation and the solid lines denote slow-axis propagation.

FIG. 3 shows a proposed setup of hybrid DPSK-MPPM long-haul system; T-SPU (R-SPU), transmitter-(receiver)-signal processing unit; PS, polarization switch; PD, photodetector; ADC, analog-to-digital converter; PC, polarization controller; PMSM, polarization maintaining single-mode fiber; DDL, discrete delay line; BERT, BER tester; MZI, Mach-Zehnder interferometer.

FIG. 4 shows an example of the transmitted signal of a hybrid DBPSK-MPPM scheme with M=4 and n=2. The phase differences due to DBPSK modulation are also shown.

FIG. 5 shows an average bit-error rate versus average received optical signal-to-noise ratio for both proposed DBPSK-MPPM and traditional DBPSK systems.

FIG. 6 shows an average bit-error rate versus average received optical signal-to-noise ratio for proposed DQPSK-MPPM system, traditional DBPSK, and traditional DQPSK systems.

FIG. 7 shows a proposed systems receiver sensitivity improvement over traditional DBPSK system at BER=10⁻⁹.

FIG. 8 shows an average bit-error rate versus average received optical signal-to-noise ratio for both hybrid DBPSK-MPPM and traditional MPPM systems.

FIG. 9 shows an average bit-error rate versus average received optical signal-to-noise ratio for both hybrid DQPSK-MPPM and traditional MPPM systems.

FIG. 10 shows a graph of bandwidth-utilization efficiency as a function of log₂ M.

FIG. 11 shows a graph of bandwidth-utilization efficiency as a function of n.

FIG. 12 shows an average bit-error rate versus OSNR_{ref} for both hybrid DBPSK-MPPM and PQ-16PPM systems.

FIG. 13 shows an average bit-error rate versus average OSNR for both hybrid DBPSK-MPPM and BPSK-modified MPPM systems.

### DETAILED DESCRIPTION OF THE INVENTION

A novel ultrafast discrete delay unit capable to preserve the state of polarization (SOP) and the phase of the input pulse is a critical part of the present invention. Consider a linearly polarized optical pulse fed into an electro-optic polarization switch (PS) whose two operational states; either to leave the SOP unchanged or to flip it to the orthogonal state. The PS is followed by a highly birefringent polarization-maintaining single-mode (PMSM) fiber of length L oriented such that its slow and fast axes are precisely aligned with the two possible SOPs emerging from the PS. It is well known that, by virtue of its highly asymmetric structure or refractive-index, PMSM fiber allows guiding two principal SOP of monochromatic light at strict timing and phase relations without significant distortion. This feature highlights the merit of the PMSM fiber as a precise optical delay line preserving the phase information. Therefore, this apparatus can switch between two possible delay times; either τₛ=L/v_{g}^{slow} corresponding to the group velocity of the slow axis v_{g}^{slow}, or τ_{f}=L/v_{g}^{fast} corresponding to the group velocity of the fast axis v_{g}^{fast}, based on the binary control of the PS (set in the present invention by signal processing and decision circuitry).

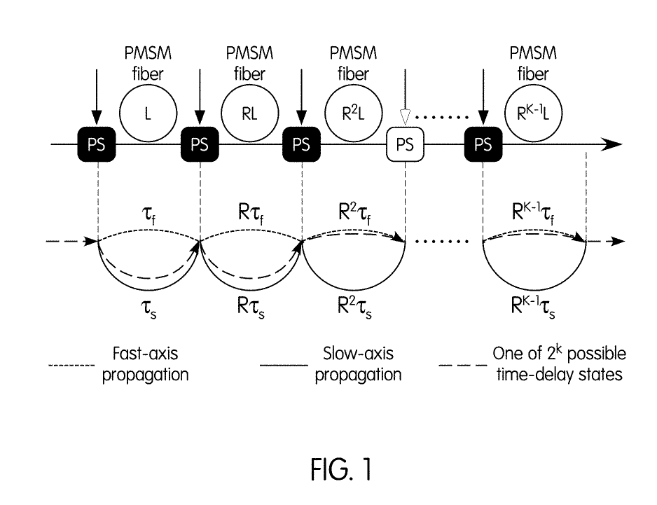

Consider a series of K of such delay stage with each one equipped with PMSM fiber segment of length R-multiples of that of the preceding one (see the schematic diagram in FIG. 1). The fast and slow axes of all fiber segments and the PSs are aligned together, so that the manipulation of the SOP along the cascaded stages can assign the delay time of the emerging optical pulse to be one of the 2^{K} choices {τ_{f}Σᵢ₌₀^{K-1}Rⁱ; τₛ+τ_{f}Σᵢ₌₁^{K-1}Rⁱ; Rτₛ+(1+Σᵢ₌₂^{K-1}Rⁱ)τ_{f}; (1+R)τₛ+τ_{f}Σᵢ₌₂^{K-1}Rⁱ; R²τₛ+τ_{f}(1R+Σᵢ₌₃^{K-1}Rⁱ); . . . ; τₛΣᵢ₌₀^{K-1}Rⁱ}. For an optical pulse, input to the system at time t₀, it can be then positioned at 2^{K} different time instants, where the first time instant is at t₀+τ_{f}Σᵢ₌₀^{K-1}Rⁱ.

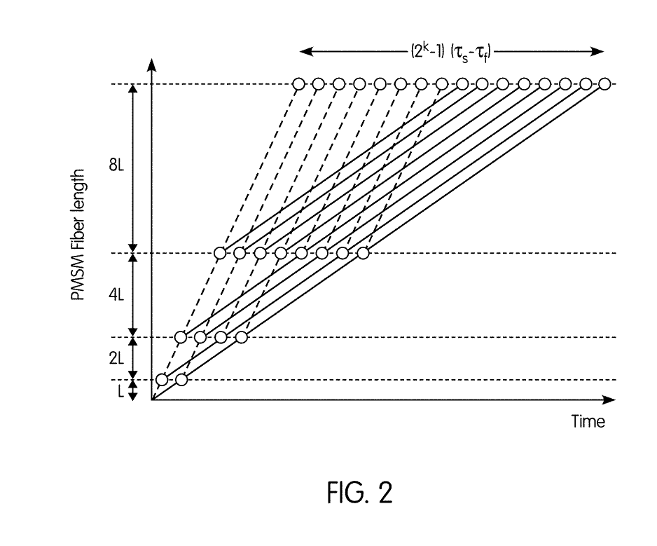

In general, these train of time instants are separated either by fixed time interval (τₛ−τ_{f}) or by variable intervals which are functions of the parameter R. However, a fixed time interval (τₛ−τ_{f}) can be realized between all delay times under the condition R=2, as depicted in FIG. 2. This condition can be interpreted using an analogy to the binary numbering system as there are only two possible operational states per stage.

An advantage of the ultrafast discrete delay unit is the relatively short optical fiber required to realize optical delays, compared with other methods utilizing the wavelength tuning and chromatic dispersion. To clarify this point, consider this quantitative example. To make an optical pulse span 1.5 ns delay interval at steps of 0.1 ns, if a PMSM fiber with differential group delay about 29.3 ps/m near the wavelength 1550 nm is used, a 51.19 m total fiber length is required along a number of 4 stages with the fiber length of the first stage about 3.41 m. The short fiber length serves the delay system by limiting the pulse broadening effects caused by dispersion. Hence, there is no need for pre- and post-compensators used to recover the pulse width in other delay control systems utilizing much longer optical fibers.

Another advantage is the capability of the system to manipulate high-rates of optical pulses. Because each stage can switch between two operational states independent from the neighboring stages, different optical pulses can be simultaneously handled while sequentially propagating along the system. Therefore, the rate of the system is determined by the switching rate of the used PSs. Fortunately, current technologies offer a plethora of ultrafast PSs. For example, recent advances of GaAs-, silicon-, and photonic-crystal-based PS can reach data rates up to 40-50 Gbit/s.

One more advantage is that the optical pulse emerging from PMSM fiber has a well defined polarization and phase with respect to the input, allowing for compensation for the polarization and phase changes using two additional PSs. This feature is essential for time division schemes that require extracting the phase information in a subsequent measurement system. It worth mentioning that by integrating this tunable optical delay unit to the receiver system, as described below, the proposed DPSK-MPPM modulation system is ready to operate at adjustable (or variable) data rates.

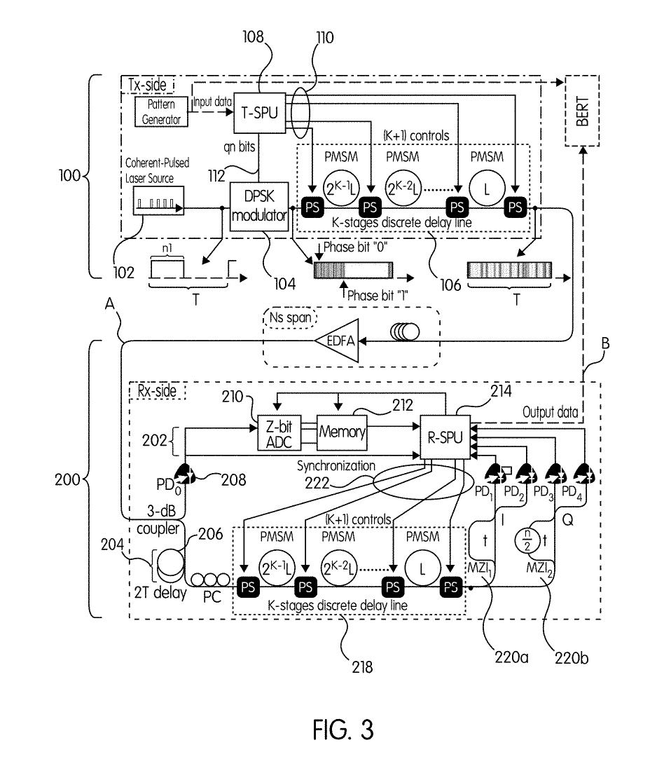

The proposed transmitter 100 is depicted in FIG. 3. Transmitter 100 sends data symbols within time frames. Each time frame has a duration T and is composed of M disjoint slots. Coherent optical pulses (each of pulsewidth τ=T/M) are signaled within n slots of each time frame. A coherent laser source 102 emits single-mode light pulses at a rate 1/T , with each pulse having a period nτ. The pulsed laser emission has a coherence time longer than 2T, thereby allowing phase information to be reserved along two sequential pulses. In the preferred embodiment, the coherent pulsed laser source acts on the emission of a coherent continuous wave diode laser with a fast optical switch. A subsequent traditional DPSK modulator 104 encodes qn phase bits per pulse, where q=1 in case of DBPSK and q=2 in case of DQPSK.

The qn bits modulated light pulse is fed to the MPPM modulator 106, which consists of a K-stages ultra-fast discrete delay line, as described above, capable of applying up to 2^{K} discrete delay steps, where L is the shortest length of polarization-maintaining single-mode (PMSM) fiber per delay stages. This discrete delay line 106 modulates the position of each phase-modulated time-slot pulse into one of M locations, where the number of available slot positions per frame M≦2^{K}. The synchronized electro-optic polarization switching within the delay line precisely chops the phase-modulated pulse into n pulses. Both the DPSK modulator 104 and MPPM modulator 106 are controlled via the transmitter signal processing unit (T-SPU, 108), which is synchronized to the pulsed laser source 102, thereby carrying out the precise timing required by the hybrid DPSK-MPPM modulation. The input data of T-SPU 108 is thus └log₂(ₙ^{M})┘+qn bits. While DPSK data (qn bits) is forwarded by T-SPU 108 directly to DPSK modulator 104 via 112, MPPM data (└log₂(ₙ^{M})┘ bits) is manipulated first by T-SPU 108 to produce the K delay controls 110. In addition, a subsequent control is used to unify the polarization of the delay output regardless of the introduced delay. It should be mentioned that, based on the current state of technology, the proposed DPSK-MPPM system is capable of manipulating high data rates up to 50 Gbit/s.

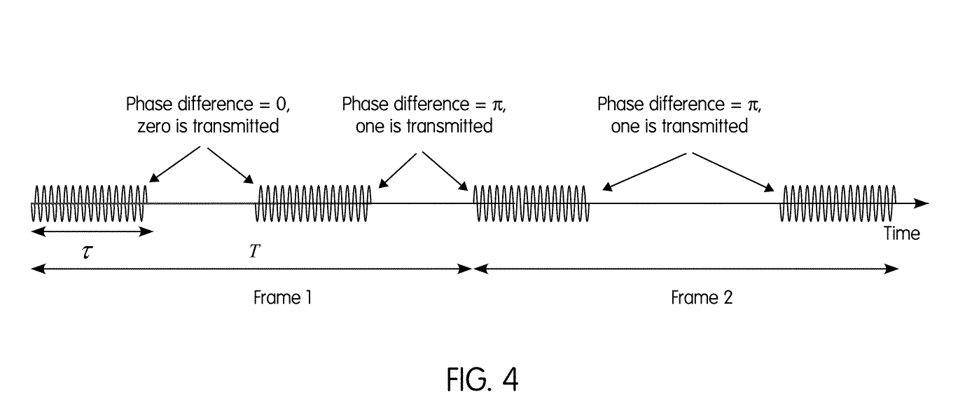

An example of the transmitted signal of a hybrid DBPSK-MPPM scheme with M=4 and n=2 is shown in FIG. 4.

At receiver 200, the received signal A is split into two distinct arms, MPPM 202 and DPSK 204 receivers, as shown in FIG. 3. To decode the phase information, the positions of the active n slots should be defined first. A photodetector 208 on the MPPM (upper) arm 202 listens to the optical intensity along the frame period and feeds a subsequent Z-bits analog-to-digital converter (ADC) 210. The ADC 210 and its memory storage 212 are triggered by the edge of time-slot clock generated by the receiver signal-processing unit (R-SPU) 214. This clock is precisely synchronized to the transmitter's pulses by transmitting a periodic reference frame. The memory storage 212 records the signal intensity within each time slot, whether occupied or not. The R-SPU 214 runs a comparison routine on the M stored values, resulting in a soft decision regarding the position of the most occupied n time slots. On the DPSK arm 204, a two frame delay 206 holds the processing of the phase information until the best decision regarding the active n time-slot positions is made by R-SPU 214. R-SPU 214, being aware of the positions of the time slots, can adapt the receiver delay line 218 to act by the complementary delay made by transmitter 100 for each signal slot, thereby reallocating them in contiguous time slots.

The phase encoded signal is then split between two Mach-Zehnder interferometers (MZIs) 220a and 220b, whose unbalanced arms differ precisely by the time-slot period τ, while one of them involves π/2 phase shift between its two arms. Although only one MZI is sufficient for DBPSK decoding, two MZIs 218(a,b) are needed to run the phase compensation process, as will be discussed later. R-SPU 214 eventually encapsulates the DPSK bits along with the MPPM bits, recovering back the sent frame data B.

A receiver 200 equipped with a K-stages discrete delay line 218 matched to the K-stage discrete delay line 106 at transmitter 100 will certainly suffer a different delay-induced phase pattern (an ideally matched delay line, however, can perfectly compensate for the delay-induced phase). To compensate this phase perturbation, transmitter 100 and receiver 200 run an initial reconciliation routine as follows. Transmitter 100 sends a training sequence, which has no phase information. This frame has M contiguous signal slots with the first slot traversing the fastest path along the PMSM fiber of all stages, while each following signal slot trains one of the delay steps in the K-State discrete delay line 218 of receiver 200 in order. This training sequence is thus chopped owing to the different delay of each signal slot while conveying solely the phase accumulated by the delay line of the transmitter for each delay possibility. R-SPU 214 acts using the receiver delay line 218 on each frame slot by a delay value complementary to that of the transmitter, thereby recombining the signal slots. Then, using the two MZIs 218(a,b) in the I and Q arms, receiver 200 measures the relative phase accumulated (due to the delay lines of transmitter 100 and receiver 200) within each slot compared with the preceding one. R-SPU 214 then stores the absolute phase value corresponding to each delay step to be able to compensate for the delay-induced phase.

Numerical Results

We investigate the bit error rate of the proposed hybrid and traditional modulation techniques in optical amplifier-noise limited channels.

In all the figures, comparisons are made under the same average received optical signal-to-noise ratio and same transmission data rate for both the proposed and the traditional systems. Furthermore, it is assumed that all systems have the same receiver bandwidth, except for traditional DQPSK systems (because the comparison with traditional DQPSK systems cannot be made under the same transmission data rate and receiver bandwidth simultaneously). Thus, it is assumed that traditional DQPSK system has the same transmission data rate but half the receiver bandwidth of other systems under comparison.

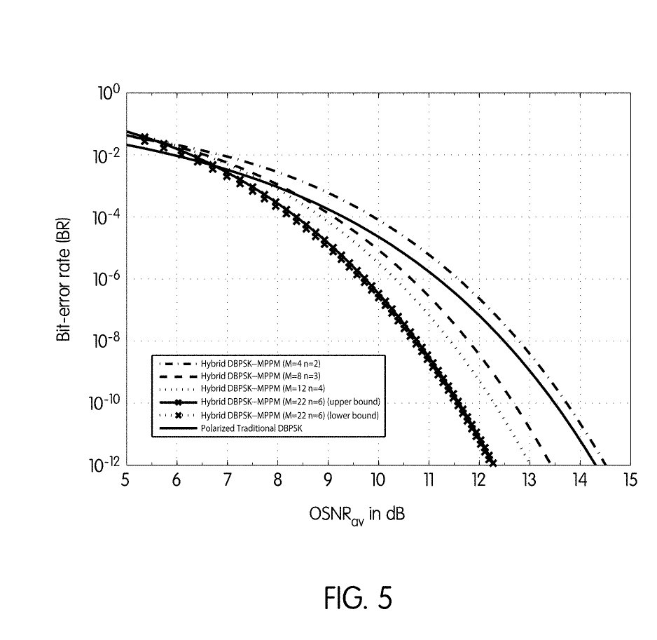

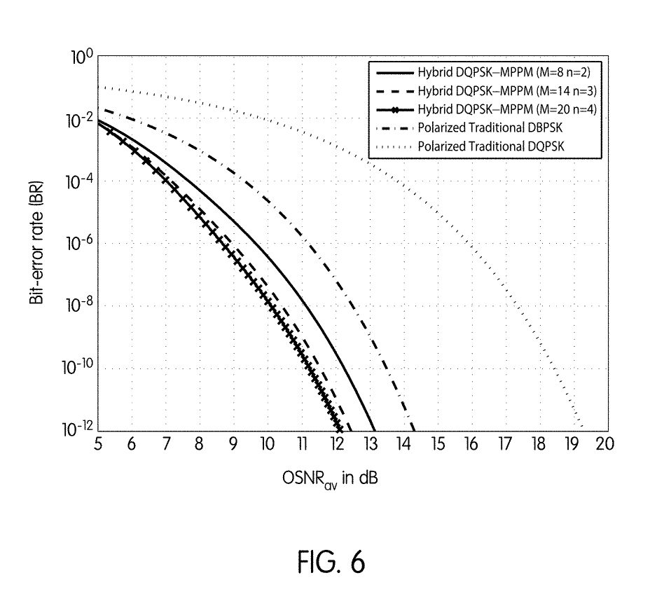

It can be seen from FIG. 5 that the proposed systems perform better than the corresponding traditional DBPSK systems. Specifically from FIG. 5, for the proposed DBPSK-MPPM system with M=22 and n=6, there is an improvement of about 1.8 dB at BER=10⁻⁹ when compared to polarized DBPSK system. Moreover, the lower and the upper bounds are very close to each other. This emphasizes that the upper bound is tight to the exact BER expression. Furthermore, it can be seen from FIG. 6 that for the propose DQPSK-MPPM system with M=20 and n=4, there is an improvement of about 2.4 dB at BER=10⁻⁹ when compared to the polarized DBPSK system.

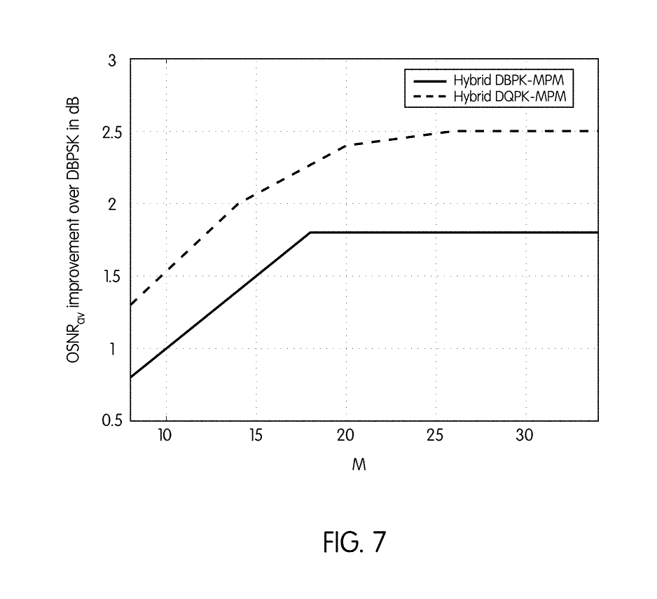

FIG. 7 shows the receiver sensitivity improvement of the proposed systems over traditional DBPSK system at BER=10⁻⁹ as a function of M, in case of transmitting the same data rate at the same bandwidth. For all the values of M, the proposed systems surpass the traditional DBPSK system. As shown, the improvement increases gradually with increasing M, until reaching its saturation at M=18 for proposed DBPSK-MPPM system and M=20 for proposed DQPSK-MPPM system.

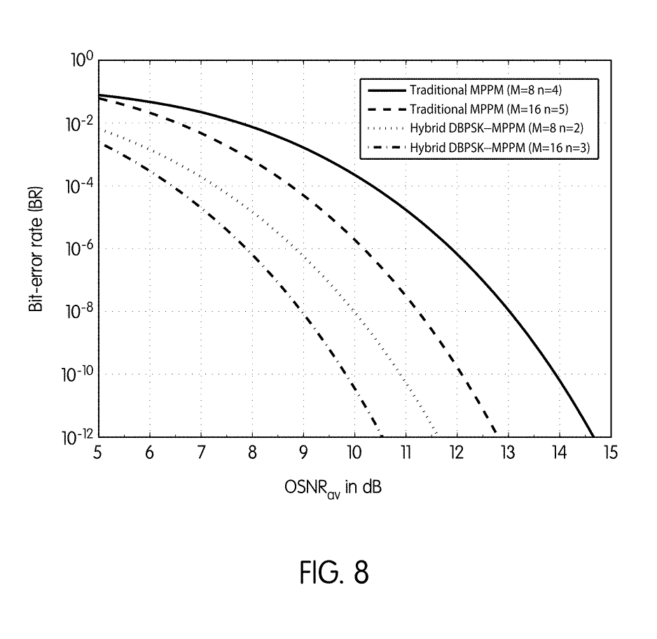

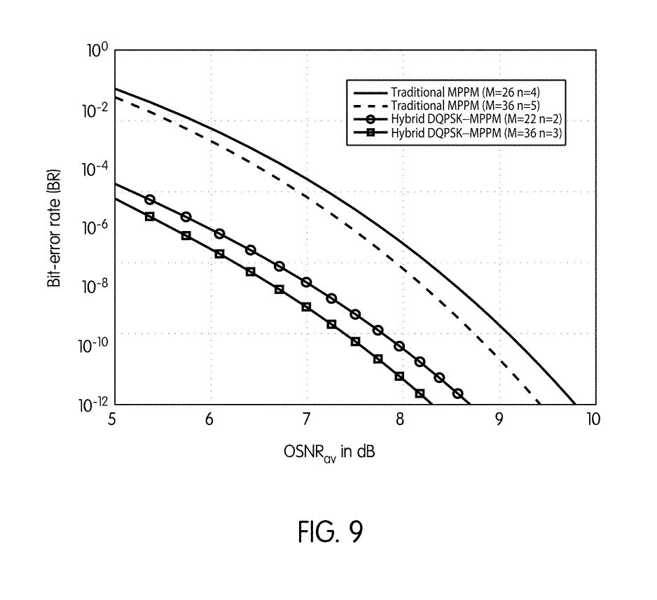

FIG. 8 shows that, under the above conditions, the hybrid systems perform better than corresponding traditional MPPM systems. Specifically, FIG. 8 shows that there is an improvement of about 2.2 dB at BER=10⁻⁹ for hybrid DBPSK-MPPM system (of M=16 and n=3) when compared with traditional MPPM system (of M=16 and n=5). Moreover, FIG. 9 shows, that there is an improvement of about 1.5 dB at BER=10⁻⁹ for hybrid DQPSK-MPPM system (of M=36 and n=3) when compared with traditional MPPM system (of M=36 and n=5).

The reason behind all the previous improvements can be explained as follows. In the case of transmitting the same data rate at the same bandwidth and average received optical signal-to-noise ratio, hybrid systems have higher peak power per slot as compared to corresponding traditional systems. This leads to a higher signal-to-noise ratio and improved BER.

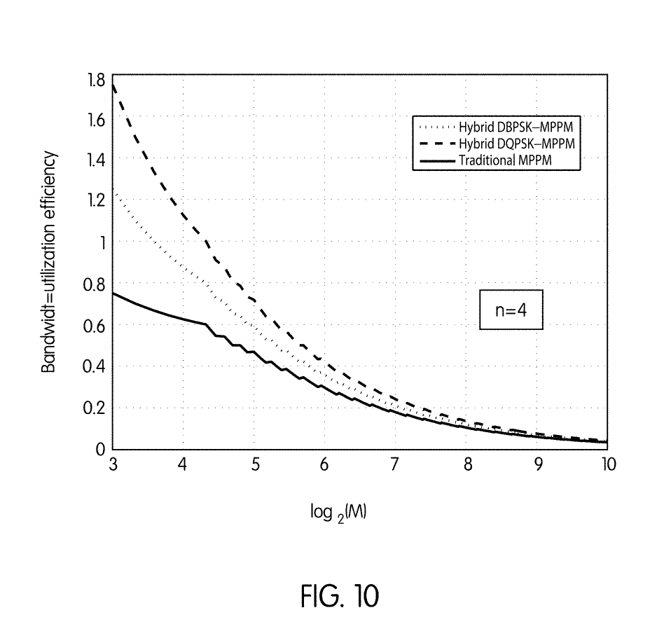

In FIG. 10 shows plot of the bandwidth-utilization efficiency (BWUE) versus log₂ M under a fixed value of n=4 for the proposed and traditional MPPM systems. As shown, increasing M results in a gradual decrease of bandwidth-utilization efficiency until reaching its saturation at large values of M. FIG. 10 also shows that the proposed systems further enhance the bandwidth-utilization efficiency of traditional DBPSK (BWUE_{DBPSK}=100%) under certain values of M and n and further enhance the bandwidth-utilization efficiency of MPPM systems for all values of M and n.

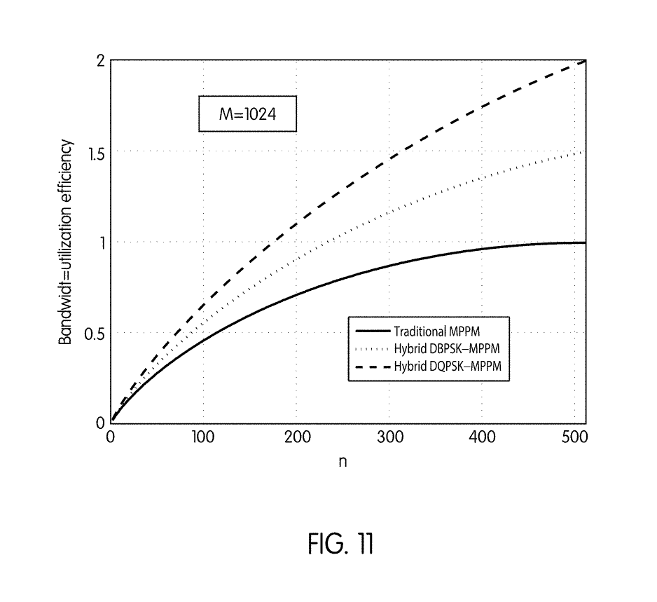

FIG. 11 is a plot of the bandwidth-utilization efficiency versus n under a fixed value of M=1024 for the MPPM system o the present invention versus a traditional MPPM system. As shown, increasing n would result in a gradual increase of bandwidth-utilization efficiency. To reach the value of bandwidth-utilization efficiency of traditional DQPSK systems (BWUE_{DQPSK}=200%), hybrid DQPSK-MPPM systems need to use large values of M and n. That is, the traditional DQPSK system is more bandwidth efficient than hybrid DQPSK-MPPM system. However, the receiver of the latter is more sensitive than traditional DQPSK receiver. Furthermore, the system of the present invention further enhances the bandwidth-utilization efficiency of MPPM systems for all values of M and n.

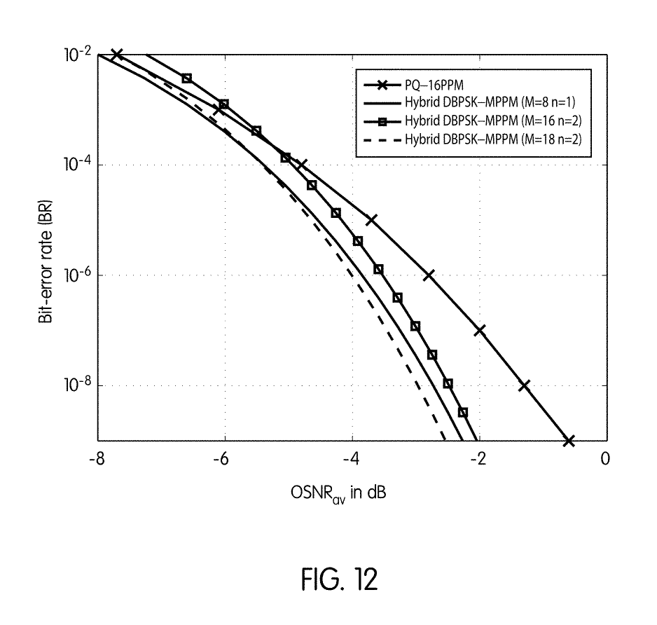

FIG. 12 is a plot of the BER versus OSNR_{ref} for the proposed and the hybrid polarization-division-multiplexed quadrature phase-shift keying-m-ary pulse-position modulation (PQ-mPPM) systems. Although the PQ-16PPM system has higher peak power than the system of the present invention, it can be seen from FIG. 12 that the proposed systems nearly have the same performance as the PQ-16PPM system at the FEC limit of BER=10⁻³, however the proposed systems perform better than the corresponding PQ-16PPM system at BER=10⁻⁹. Specifically, for the proposed DBPSK-MPPM system with M=8 and n=1, there is an improvement of about 1.7 dB at BER=10⁻⁹ when compared to the PQ-16PPM system. Without implementing FEC schemes, the proposed systems would achieve the required BER. Furthermore, our proposed systems are more bandwidth efficient than PQ-mPPM system.

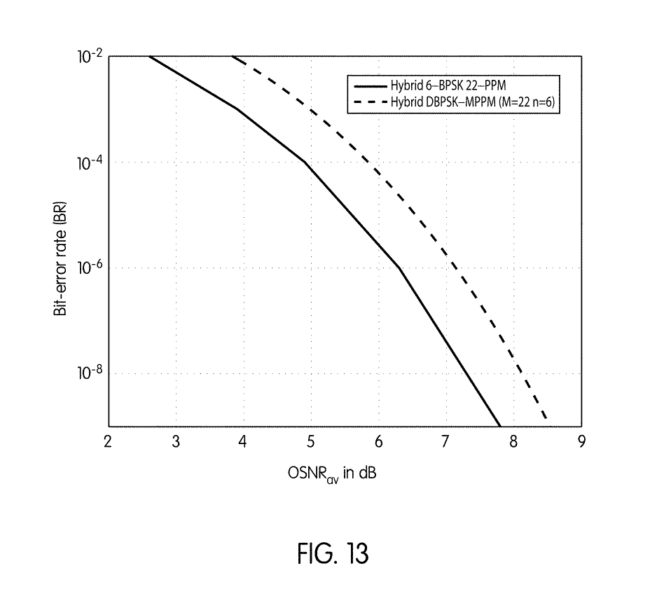

FIG. 13, is a plot of the BER versus OSNRₐᵥ for the proposed and hybrid BPSK-modified MPPM systems. FIG. 13 shows that there is a little improvement of about 0.7 dB at BER=10⁻⁹ of the hybrid BPSK-modified MPPM system over the corresponding proposed DBPSK-MPPM system. Furthermore, the proposed DBPSK-MPPM system has the same bandwidth-utilization efficiency as that of BPSK-modified MPPM system. However, the BPSK-modified MPPM system is less bandwidth efficient than that of the proposed DQPSK-MPPM system.

1. A transmitter for transmitting an optical signal, comprising:
a coherent pulse light source;
a differential phase shift keying modulator (DPSK), for modulating said optical signal using said coherent pulse light source;
a multipulse pulse position modulator (MPPM) for further modulating said optical signal; and
a signal processing unit for controlling said differential phase shift keying modulator and said multipulse pulse position modulator.

2. The transmitter of claim 1 wherein said DPSK modulator is one of a binary modulator or a quadrature modulator.

3. The transmitter of claim 1 wherein said MPPM comprises one or more stages, each stage comprising:
an electro-optic polarization switch, said electro-optic polarization switch capable of either maintaining the state of polarization of said optical signal or flipping the state of polarization to an orthogonal state; and
a polarization-maintaining single mode (PMSM) fiber of a predetermined length, said length being selected to apply a delay due to the propagation of said optical signal across said PMSM fiber.

4. The transmitter of claim 1 wherein said signal processing unit performs the functions of:
synchronizing an internal clock with said coherent pulsed light source;
feeding said optical signal to said DPSK modulator; and
manipulating said optical signal to produce a control signal for said MPPM.

5. The transmitter of claim 1:
wherein said transmitter creates time frames of length T for containing data from said optical signal, each time frame composed of M slots; and
wherein said coherent pulsed light source creates pulses of length nT/M.

6. A receiver for receiving an optical signal, said optical signal containing data in time frames, each time frame having defined time slots, comprising:
a splitter for splitting said optical signal;
an MPPM demodulator, said MPPM demodulator receiver said optical signal from said splitter;
a delay unit having one or more delay stages, said delay unit receiving a delayed optical signal from said splitter;
a signal processing unit for controlling said MPPM demodulator and said delay unit; and
two interferometers, one of which has a phase shift.

7. The receiver of claim 6 wherein said MPPM demodulator comprises:
a photodetector; and
an analog-to-digital converter (ADC) coupled to said photodetector, for decoding said optical signal to digital form; and
memory for storing the intensity of said decoded signal within each time slot of each time frame;

8. The receiver of claim 6 wherein said signal processing unit has a clock which is synchronized by a received pulse from a transmitter of said optical signal.

9. The receiver of claim 7 wherein said signal processing unit decides, based on the output of said ADC, which n time slots in each time frame are likely the most occupied;

10. The receiver of claim 9 further comprising a two-frame delay which holds said received optical signal for two time frames until said signal processing unit decides which n time slots in each frame likely the most occupied.

11. The receiver of claim 6 wherein said delay unit has a number of delay stages equal to the number of delay stages used by a transmitter of said optical signal.

12. A system for communicating an optical signal, comprising:
a transmitter, said transmitter performing the functions of:
processing said optical signal with a differential phase shift keying (DPSK) modulator;
further processing said optical signal with a multipulse pulse position modulator (MPPM); and
transmitting said twice-modulated optical signal; and
a receiver, said receiver performing the functions of:
receiving said optical signal from said transmitter;
splitting said optical signal into two paths, a first path being coupled to an MPPM demodulator and a second path being coupled to a DPSK demodulator;
controlling said DSPK demodulator based on the output of said MPPM demodulator.

13. The system of claim 12 wherein said DSPK modulator uses a coherent pulsed light source to modulate said optical signal.

14. The system of claim 13:
wherein said transmitter creates time frames of length T for containing data from said optical signal, each time frame composed of M slots; and
wherein said coherent pulsed light source creates pulses of length nT/M.

15. The system of claim 13 wherein said coherent pulsed light source is a laser acted on by an optical switch.

16. The system of claim 12 wherein said MPPM comprises one or more stages, each stage comprising:
an electro-optic polarization switch, said electro-optic polarization switch capable of either maintaining the state of polarization of said optical signal or flipping the state of polarization to an orthogonal state; and
a discrete delay unit for delaying said optical signal.

17. The system of claim 16 wherein said discrete delay unit comprises:
one or more delay stages, each of said delay stages comprising:
an electro-optic polarization switch, said electro-optic polarization switch; and
a length of polarization-maintaining single mode (PMSM) fiber;

18. The system of claim 17 wherein said electro-optic polarization switch is capable of either maintaining the state of polarization of said optical signal or flipping the state of polarization to an orthogonal state.

19. The system of claim 17 wherein said PMSM fiber is of a predetermined length, said length being selected to apply a delay due to the propagation of said optical signal across said PMSM fiber.

20. The system of claim 18 wherein PMSM fiber is oriented such that its slow and fast axes are aligned with the two possible states of polarization of said electro-optic polarization switch.
